(19) United States
(12) Patent Application Publication
(10) Pub. No.: US 2007/0236426 A1
(43) Pub. Date: Oct. 11, 2007

(54) Method for driving display

(76) Inventors: Chih-Heng Chu, Hsinhua (TW); Ming-Cheng Chiu, Hsinhua (TW); Jeh-Chuen Chen, Hsinhua (TW)

Correspondence Address: J.C Patents, Inc., Suite 250, 4 Venture, Irvine, CA, 92618, US

(21) Appl. No.: 11/472,721

(22) Filed: Jun. 21, 2006

(30) Foreign Application Priority Data
Apr. 7, 2006 (TW) 95112375

(51) Int. Cl. G09G 3/30

(52) U.S. Cl. 345/77

(57) ABSTRACT

A method for driving a display is disclosed. The method is particularly useful for driving a passive matrix organic light-emitting diode (PMOLED) display. The method includes the following steps. First, a preparation gray level and a current gray level for the pixels within a scan line to be displayed are detected. Then, a pre-charge voltage and a discharge voltage for the pixels within the scan line are adjusted according to the preparation gray level and the current gray level.

### CROSS-REFERENCE TO RELATED APPLICATION

This application claims the priority benefit of Taiwan application serial no. 95112375, filed on Apr. 7, 2006. All disclosure of the Taiwan application is incorporated herein by reference.

### BACKGROUND OF THE INVENTION

1. Field of the Invention

The present invention relates to a driving method, and more particularly, to a method of driving a passive matrix organic light-emitting diode (PMOLED) display.

2. Description of Related Art

Organic light-emitting diode (OLED) displays can be classified in terms of their driving methods into passive matrix organic light-emitting diode (PMOLED) displays and active matrix organic light-emitting diode (AMOLED) displays. The advantages of a PMOLED display includes a simple structure that requires no driving thin film transistors and a relative low manufacturing cost. However, one major disadvantage of the PMOLED display is that it is not suitable for high-resolution-image applications. Moreover, when used in large-sized applications, the PMOLED display is also problematic in its larger power consumption, shorter life span and poorer display performance.

In a conventional driving method, to lower the power consumption of the PMOLED display, pre-charging before current driving and discharging after current driving can be used. In general, the pre-charge voltage and the discharge voltage used before and after current driving are fixed. The pre-charge voltage is normally slightly lower than the threshold voltage of the OLED element of the PMOLED display and the discharge voltage is normally 0V.

In the conventional driving method, even when the gray level for the pixels within a scan line to be displayed is zero, the OLED element will be over-biased to the pre-charge voltage before current driving. This leads to unwanted power consumption. Moreover, even when the gray level for the pixels within a scan line to be displayed is high, the OLED element will be under-biased to the discharge voltage after current driving. Again, this also leads to additional power consumption.

### SUMMARY OF THE INVENTION

Accordingly, one objective of the present invention is to provide a method of driving a display particularly a passive matrix organic light-emitting diode (PMOLED) display. The present invention adjusts the pre-charge voltage and the discharge voltage for the pixels within a scan line to be displayed according to the preparation gray level and the current gray level for the pixels within the scan line so as to eliminate unnecessary power consumption.

To achieve the above and other objectives, the invention provides a method of driving a display particularly a passive matrix organic light-emitting diode (PMOLED) display. The display includes a plurality of scan lines. The driving method includes the following steps. First, a preparation gray level and a current gray level the pixels within a scan line to be displayed are detected.

Then, according to the preparation gray level and the current gray level, a pre-charge voltage and a discharge voltage for the pixels within the scan line are adjusted. If the preparation gray level is zero, pre-charging before current driving is cancelled or the pre-charge voltage is reduced to zero to prevent unnecessary over-bias of the OLED element and power consumption. If both the current gray level and the preparation gray level are higher than a predetermined high level, the discharge voltage is raised to a predetermined high level, which is still slightly lower than a threshold voltage of the OLED element, to prevent unnecessary under-bias of the OLED element and power consumption.

In the present invention, the pre-charge voltage and the discharge voltage are adaptively adjusted according to the current gray level and the preparation gray level for the pixels within the scan line to be displayed. Therefore, improper bias of the OLED element and unwanted power consumption can be eliminated.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a PMOLED panel according to the present invention.

FIG. 2 is an equivalent circuit diagram of a pixel according to the present embodiment.

FIG. 3 is a discharging circuit for the discharging phase during the driving of a scan line of pixels according to the present embodiment.

FIG. 4 is a flow diagram showing the steps for driving a display according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

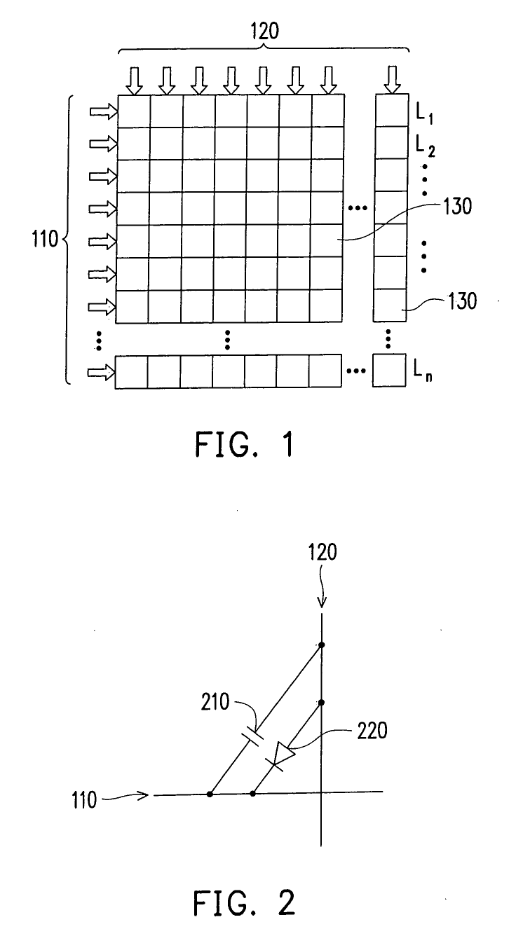

FIG. 1 is a PMOLED panel according to the present invention. As shown in FIG. 1, the PMOLED panel comprises a plurality of pixels 130 arranged in a matrix of rows and columns. Each of the pixels 130 includes an organic light-emitting diode (OLED) element. The PMOLED panel includes a plurality of scan lines L₁˜Lₙ of pixels each of them driven jointly by a row-driving signal 110 and a column-driving signal 120. The row-driving signal 110 is responsible for orderly scanning a scan line of pixels and the column-driving signal 120 is responsible for outputting a driving current to the corresponding OLED elements within the scan line. In the present embodiment, the column-driving signal 120 changes the gray levels of the pixels within the scan line by adjusting their current driving duration. For example, the current driving duration can be adjusted by means of pulse width modulation (PWM) to generate different-gray-level pixels.

FIG. 2 is an equivalent circuit diagram of a pixel according to the present embodiment. Each of the pixels 130 in the present embodiment can be modeled as a diode 220 shunted with a capacitor 210 coupled between the column-driving signal 120 and the row-driving signal 110. When the voltage drop across the diode 220 exceeds its threshold voltage, the diode 220 conducts to produce the required gray level at the pixel through the column-driving signal 120 by means of pulse width modulation (PMW).

Each of the scan lines L1˜Ln of pixels is generally driven in three phases, namely, a discharging phase, a pre-charging stage and a current driving phase. In the discharging phase, the discharge voltage for the pixels within the scan line is adjusted according to a preparation gray level and a current gray level for the pixels within the scan lin. If both the preparation gray level and the current gray level are higher than a predetermined high level, the discharge voltage is raised to a predetermined high level which is still slightly lower than the threshold voltage of the OLED element of the PMOLED display. Therefore, under-bias of the OLED element can be avoided to reduce unnecessary power consumption.

In the pre-charging phase, if the preparation gray level for the pixels within the scan line is zero, pre-charging before current driving is cancelled, or alternatively, the pre-charge voltage is reduced to zero to avoid over-bias of the OLED element and unnecessary power consumption. In the current driving phase, the gray levels for the pixels within the scan line are adjusted through the column-driving signal 120 by means of pulse width modulation (PWM).

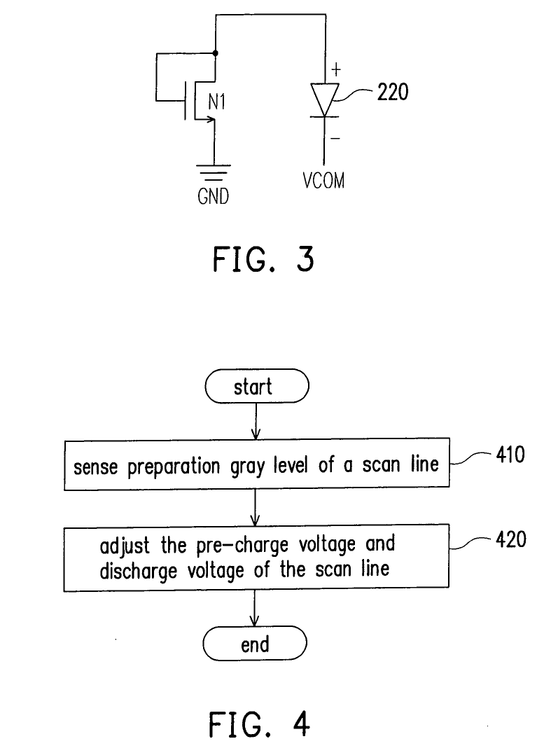

FIG. 3 is a discharging circuit for the discharging phase during the driving of the scan line according to the present embodiment. The drain of the NMOS transistor N1 is connected to the gate of the NMOS transistor N1. The NMOS transistor N1 coupled between the anode of the diode 220 and ground GND respectively at its drain and source. The signal VCOM is supplied from the row-driving signal 110. When the preparation gray level for the pixels within the scan line is higher than the predetermined high level, the discharge voltage is raised to the predetermined high level, which is still slightly lower than the threshold voltage of the OLED element of the PMOLED display. As can be shown in FIG. 3, if the voltage drop across the diode 220 is higher than the threshold voltage of the NMOS transistor N1, the NMOS transistor N1 conducts. Hence, the current of the NMOS transistor N1 is discharged to ground GND until the voltage drop across the diode 220 is reduced below its threshold value.

Thus, through the discharging circuit, the voltage drop across the diode 220 can be reduced to a voltage level that is slightly lower than the threshold voltage of the NMOS transistor N1 so as to receive the column-driving signal 120.

FIG. 4 is a flow diagram showing the steps for driving a display according to the present invention, particularly a PMOLED display. The display includes a plurality of scan lines. The driving method includes the following steps. First, in step 410, the preparation gray level for the pixels within a scan line to be displayed and the current gray level for the pixels within the scan line are detected.

Then, in step 420, according to the preparation gray level, the pre-charge voltage for the pixels within the scan line is adjusted. If the preparation gray level for the pixels within the scan line is zero, pre-charging before current driving can be cancelled, or alternatively, the pre-charge voltage is reduced to zero to avoid over-bias of the OLED element and unnecessary current consumption.

Further, in the step 420, the discharge voltage for the pixels within the scan line is adjusted according to the current gray level and the preparation gray level. If both the current gray level and the preparation gray level are higher than the predetermined high level, the discharge voltage for the pixels within the scan line is raised to a predetermined high level. Note, the predetermined high level is still slightly lower than the threshold voltage of the OLED element of the PMOLED display. In other words, if the preparation gray level is higher, the discharge voltage is raised to the predetermined high level so as to avoid under-bias of the OLED element and unnecessary current consumption.

In summary, the present embodiment adjusts the discharge voltage and the pre-charge voltage for the pixels within the scan line according to the preparation gray level and the current gray level. Therefore, unwanted under-bias and over-bias of the OLED element and unnecessary the power consumption for driving the display can be effectively eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of driving a display, particularly a passive matrix organic light-emitting diode (PMOLED) display having a plurality of scan lines, comprising steps of:
detecting a preparation gray level for a plurality of pixels within a scan line to be displayed; and
adjusting a pre-charge voltage of the scan line according to the preparation gray level.

2. The driving method of claim 1, wherein the step of adjusting the pre-charge voltage according to the preparation gray level comprises, if the preparation gray level is zero, cancelling a pre-charging before current driving operation for the pixels within the scan line or reducing the pre-charge voltage to zero.

3. The driving method of claim 1, further comprising detecting a current gray level for the pixels within the scan line.

4. The driving method of claim 3, further comprising adjusting a discharge voltage for the pixels within the scan line according to the current gray level and the preparation gray level.

5. The driving method of claim 4, wherein the step of adjusting the discharge voltage according to the current gray level and the preparation gray level comprises, if both the current gray level and the preparation gray level are higher than a predetermined high level, raising the discharge voltage to a predetermined high level.

6. The driving method of claim 5, wherein the predetermined high level is lower than a threshold voltage of a pixel element of the display.

7. A method of driving a display, particularly a passive matrix organic light-emitting diode (PMOLED) display having a plurality of scan lines, comprising the steps of:
detecting a preparation gray level for a plurality of pixels within a scan line to be displayed; and
adjusting a discharge voltage for the pixels within the scan line according to the preparation gray level.

8. The driving method of claim 7, further comprising detecting a current gray level for the pixels within the scan line.

9. The driving method of claim 8, further comprising adjusting the discharge voltage according to the current gray level.

10. The driving method of claim 9, wherein the step of adjusting the discharge voltage according to the preparation gray level and the current gray level comprises, if both the current gray level and the preparation gray level are higher than a predetermined high level, raising the discharge voltage to a predetermined high level.

11. The driving method of claim 10, wherein the predetermined high level is lower than a threshold voltage of a pixel element of the display.
